(19) United States
(12) Patent Application Publication
(10) Pub. No.: US 2008/0111851 A1
(43) Pub. Date: May 15, 2008

(54) Printing Mechanism with Ink Spray Suction

(75) Inventor: Wolfgang Muhl, Hohen Neuendorf (DE)

Correspondence Address: LERNER GREENBERG STEMER LLP, P O BOX 2480, HOLLYWOOD, FL, 33022-2480, US

(73) Assignee: FRANCOTYP-POSTALIA GMBH, Birkenwerder (DE)

(21) Appl. No.: 11/939,832

(22) Filed: Nov. 14, 2007

(30) Foreign Application Priority Data
Nov. 14, 2006 (DE) 102006053821.8-21

(51) Int. Cl. B41J 2/165

(52) U.S. Cl. 347/30

(57) ABSTRACT

A printing mechanism, especially for a franking machine, has a print head operating by the ink jet principle and a suction mechanism for suctioning away the ink spray arising when ink drops are ejected from at least one nozzle of the print head. The suction mechanism has a suction inlet, which in at least one first operating condition of the print head, when the print head is ejecting ink drops from the at least one nozzle, is arranged directly next to the at least one nozzle, so that a substantially undisturbed suction flow can be created between the at least one nozzle and the suction inlet.

### CROSS-REFERENCE TO RELATED APPLICATION

This application claims the priority, under 35 U.S.C. § 119, of German patent application DE 10 2006 053 821.8-27, filed Nov. 14, 2006, and which is herewith incorporated by reference in its entirety.

### BACKGROUND OF THE INVENTION

### Field of the Invention

The present invention pertains to a printing mechanism, especially for a franking machine, with a printing head, operating by the ink jet principle, and a suction mechanism for suctioning away the ink spray arising when ink drops are ejected from at least one nozzle of the printing head. Furthermore, the invention concerns a corresponding method for operating such a printing mechanism.

Printing mechanisms which work by the ink jet principle, and often also used in franking machines today, generally have the problem that when ink drops needed to create the printed image on a substrate, such as a letter, are ejected or when they strike the substrate, tiny ink droplets are formed, which because of their low weight form an ink spray or vapor. Air currents caused by moving parts of the printing mechanism or the moving substrate, and also by convection, carry the ink spray even to distant areas of the printing mechanism. This ink spray often settles on components of the printing mechanism, so that they become fouled and might even be impaired in their operation. Furthermore, if these components are such as come into contact with the substrate being printed upon, troublesome soiling of the substrate can also occur.

In order to alleviate this problem, a number of printing mechanisms of this kind have been proposed, in which suction is provided, which aspirates away the ink spray in the machine in order to prevent such soiling. Such printing mechanisms are known, for example, from U.S. Pat. No. 5,831,655 (cf. DE 196 11 700 A1), U.S. Pat. Nos. 5,589,866; 5,446,487; 5,406,316; and 5,296,873 (cf. EP 0 622 243 A2) and German published patent application DE 30 42 122 A1.

In all these printing mechanisms, the ink spray is sucked away along a more or less long, usually heavily curved and/or angled stretch to a filter or the like, which takes up the ink droplets. While in this way one prevents the ink spray from settling in uncontrolled manner onto components of the printing mechanism, thereby soiling them, the problem still exists that, especially in regions where the suction current undergoes a sudden change of direction, the droplets of the ink spray are hurled against neighboring walls or the like by centrifugal forces acting on them and then soil these usually hard to reach areas.

### BRIEF SUMMARY OF THE INVENTION

It is accordingly an object of the invention to provide a printing device with an ink vapor evacuation system which overcomes the above-mentioned disadvantages of the heretofore-known devices and methods of this general type and which provides for a printing mechanism and a method for operating a printing mechanism which does not have the above-mentioned drawbacks or at least has less of them, and which especially enables the least unwanted soiling of components of the printing mechanism.

With the foregoing and other objects in view there is provided, in accordance with the invention, a printing mechanism, in particular for a franking machine, comprising:

an ink jet print head having at least one nozzle;

a suction mechanism configured for suctioning away ink spray formed when ink drops are ejected from said least one nozzle of said print head;

said suction mechanism having a suction inlet which, in at least one first operating condition of said print head, with said print head ejecting ink droplets from said at least one nozzle, is disposed directly adjacent said at least one nozzle, thereby defining a substantially undisturbed suction flow between said at least one nozzle and said suction inlet.

In other words, the present invention is based on the technical teaching that one can make possible the least unwanted soiling of components of the printing mechanism if the suctioning of the ink spray occurs via a suction inlet of a suction mechanism such that a basically undisturbed suction flow is produced between the nozzle or nozzles of the print head and the suction inlet when suctioning away the ink spray (i.e., ink mist, ink vapor).

Thanks to the close spatial coordination of the suction inlet with the nozzle or nozzles of the printing mechanism, it is possible in advantageous fashion to suck the resulting ink spray away directly, in particular without it having to pass by functional components of the printing mechanism, whose fouling is undesirable. Such functional components are, for example, electrical contacts, sensors, moving or nonmoving mechanical components, such as guide surfaces and transport mechanisms for the substrate being printed upon, joints, etc. Moreover, it is possible to avoid abrupt changes of direction of the suction flow on the short path between the respective nozzle and the suction inlet, so that ink deposits due to centrifugal force can be avoided in the region of such changes of direction of the suction flow.

Therefore, according to one aspect the present invention concerns a printing mechanism, especially for a franking machine, with a print head, operating by the ink jet principle, and a suction mechanism for suctioning away the ink spray arising when ink drops are ejected from at least one nozzle of the print head. The suction mechanism has a suction inlet, which in at least one first operating condition of the print head, when the print head is ejecting ink drops from the at least one nozzle, is arranged directly next to the at least one nozzle, so that an essentially undisturbed suction flow can be created between the at least one nozzle and the suction inlet.

The short stretch between the nozzle and the suction inlet can basically be configured in any suitable manner. Preferably, the suction flow between the at least one nozzle and the suction inlet does not pass by any obstacles noticeably constricting the flow cross section. In this way, one can avoid unwanted ink deposits which otherwise could occur at such constrictions due to the flow deflection occurring there.

The suctioning can occur at any suitable times at any suitable positions of the print head. In preferred variants of the invention, the suctioning occurs in the printing position of the print head. The suctioning can occur both during a printing cycle or between consecutive printing cycles. Therefore, in these variants the print head in the first operating condition is in a printing position in which the at least one nozzle can be used to produce an imprint on a substrate positioned with respect to the print head.

Especially preferably, the suction can start during a cleaning cycle of the print head, when the print head is not ejecting the ink drops over short distance and/or onto an absorptive surface, so that the likelihood of formation of an ink spray is increased. Preferably, therefore, the print head has a free spray mode, in which the at least one nozzle is activated for cleaning purposes, and the print head in the first operating condition is in the free spray mode. Of course, there can also be several different free spray modes, for example, a brief free spray between consecutive print cycles and a more prolonged free spray at the start and/or end of the operation of the printing mechanism.

In the free spray mode, the print head can be in any suitable position. This can be, for example, a printing position in which it can also produce an imprint on a substrate. In other advantageous variants of the invention, however, it can also be provided that the print head in the free spray mode is driven into a separate free spray position, which differs from the printing position adopted by the print head when printing on a substrate. Such a separate free spray position can simplify the arrangement of the suction mechanism, especially the suction inlet.

In certain variants of the invention, there is provided an ink catching mechanism, which is arranged opposite the at least one nozzle of the print head in the free spray mode. Such a catching mechanism can also be absent, however, when the suction during the free spraying is adjusted so strong that not only the small ink droplets of the ink spray are sucked away, but also there is a suctioning away of the ink drops ejected from the print head.

The suctioning of the ink spray can occur at any suitable times, controlled by a corresponding control unit. In the most simple case, the suction occurs continuously during the entire operating time of the printing mechanism. Preferably, however, the suctioning occurs only at certain predetermined moments. This allows the suction to be operated as needed.

As mentioned, the suction mechanism can be actuated so that it is activated during the free spray mode, and preferably a predetermined run-up time is provided for the suction mechanism prior to activation of the free spray mode and/or a predetermined run-down time for the suction mechanism after deactivation of the free spray mode, in order to achieve the most complete possible suctioning of the ink spray.

The suction mechanism can have a single suction mode, in which suctioning is done with a predetermined volume flow. Preferably, several suction modes are provided, in which suctioning is done with different volume flows. This makes possible a suctioning as needed, especially during different operating modes of the print head (e.g., printing, free spraying, etc.). It should be noted here that suctioning with several different suction modes, in which suctioning is done with different volume flows, constitutes an independent patent-worthy idea, which can also be implemented independently of the spatially close arrangement of the suction inlet at the nozzle or nozzles of the print head.

Preferably, the suction mechanism has at least one intensive suction mode, in which the suction flow produced between the at least one nozzle and the suction inlet is enough to deflect ink drops ejected from the nozzle into the suction inlet. Thus, as already mentioned above, it may be possible to do away with a special ink sump, arranged opposite the print head, for the free spraying of the nozzles of the print head. It should be noted here that suctioning with such an intensive suction modes also constitutes an independent patent-worthy idea, which can also be implemented independently of the spatially close arrangement of the suction inlet at the nozzle or nozzles of the print head.

The intensive suction mode can be the sole available suction mode. Preferably, however, the suction mechanism has another suction mode, in which the suction flow formed between the at least one nozzle and the suction inlet has a lower volume flow than in the intensive suction mode, and in particular the suction flow in the other suction mode basically does not deflect the trajectory of ink drops ejected from the nozzle and deflects the ink droplets of smaller diameter, forming the ink spray, into the suction inlet.

In preferred variants of the printing mechanism, there is provided a control unit connected to the suction mechanism and the print head, which actuates the suction mechanism such that the intensive suction mode is present during a free spray mode of the print head, and in particular the control unit actuates the print head such that the free spray mode of the print head is present between the directly consecutive printing of two substrates. In this way it is possible to achieve in advantageous manner an intensive suctioning between two consecutive print cycles.

It is of special advantage when the print head in the free spray mode is situated in a printing position in which an imprint can be produced on a substrate positioned relative to the print head by the at least one nozzle in a print mode of the print head. In this way, one can achieve a fast and effective free spraying between two print cycles.

In preferred variants of the invented printing mechanism, the suction mechanism has a filter mechanism, while the filter mechanism is arranged in particular in the region of the suction inlet and/or is interchangeable. Preferably, the suction mechanism has a fan mechanism connected after the filter mechanism in the direction of flow. The filter mechanism is connected to the fan mechanism, especially via at least one air duct, such that the fan mechanism draws in air basically only through the filter mechanism. This makes sure that the entire ink spray is reliably sucked away via the filter mechanism. The suctioning can occur with any desired intensity. In particular, from time to time the suctioning can be done with increased volume flow, in order to suck ink collecting on the surface of the filter mechanism into the filter mechanism and thus prevent the formation of an ink crust clogging the filter mechanism.

In preferred variants of the invented printing mechanism, a monitoring device is provided to monitor the condition of the filter mechanism. The monitoring device is configured to put out at least one indication as to the condition of the filter mechanism, especially an indication of the need to replace the filter mechanism, especially to a user of the printing mechanism. Thus, even over a lengthy operating period of the printing mechanism, one can constantly assure a prompt replacement of the filter mechanism and, thus, a reliable filtering.

In especially simple and advantageously configured variants of the printing mechanism, the monitoring device monitors the activation of the print head and the activation of the suction mechanism and draws conclusions from this as to the current status of the filter mechanism. Thus, for example, from measurements and/or experiential values, as well as the operating times or operating volume of the print head and the suction mechanism, one can determine how much ink needs to be handled by the filter mechanism at a given time.

In especially preferred variants of the invented printing mechanism, a control unit is provided, connected to the suction mechanism, containing a monitoring device to monitor the suction flow, and the control unit is designed so that the suction flow is regulated by using a predetermined setpoint. In this way, one can easily assure, for example, that suctioning will occur with a basically constant suction flow, regardless of the increasing flow resistance of the filter mechanism with increasing ink uptake, as long as it can still be established by the suction mechanism against the flow resistance of the filter mechanism. At latest when this situation occurs, but preferably in good time, an appropriate indication will be given that the filter should be replaced.

In other preferred variants of the invented printing mechanism, the suction mechanism is configured and/or arranged so that the suction flow is interrupted and/or deflected at certain times. The interruption can occur, for example, by simply switching off the suction mechanism. Likewise, the interruption and/or deflection of the suction flow can occur by mechanical means, such as moving diaphragms, baffles, or the like. Preferably, the interruption and/or deflection of the suction flow occurs in particular by a substrate being printed upon, so that an especially simple mechanical design results.

The present invention can be used for any kinds of printing mechanisms. It can be used especially easily for printing mechanisms with print heads that are stationary for lengthy periods of time. Preferably, therefore, it is provided that the print head is fastened to a base element and it is stationary with respect to the base element when producing an imprint on a substrate, while the substrate is moved past the print head relative to the base element.

Furthermore, the present invention concerns a franking machine with a printing mechanism according to the invention.

With the above and other objects in view there is also provided, in accordance with the invention, a method of operating a printing mechanism having an ink jet print head, and of operating a franking machine with the printing mechanism. The method comprises:

ejecting ink drops from at least one nozzle of the ink jet print head;

suctioning ink spray developing during the ejecting step away with a suction inlet disposed directly adjacent the at least one nozzle and establishing a substantially undisturbed suction flow between the at least one nozzle and the suction inlet.

In other words, the present invention concerns a method for operating a printing mechanism, especially for a franking machine, with a print head, operating by the ink jet principle, wherein an ink spray arising when ink drops are ejected from at least one nozzle of the print head is sucked away. According to the invention, the ink spray is sucked away by a suction inlet, which is arranged directly next to the at least one nozzle, so that an essentially undisturbed suction flow can be created between the at least one nozzle and the suction inlet. With this inventive method, the above described advantages and variants can be realized to the same degree, so that we simply refer here to the above remarks.

Other features which are considered as characteristic for the invention are set forth in the appended claims.

Although the invention is illustrated and described herein as embodied in printing mechanism with ink spray suction, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE INVENTION

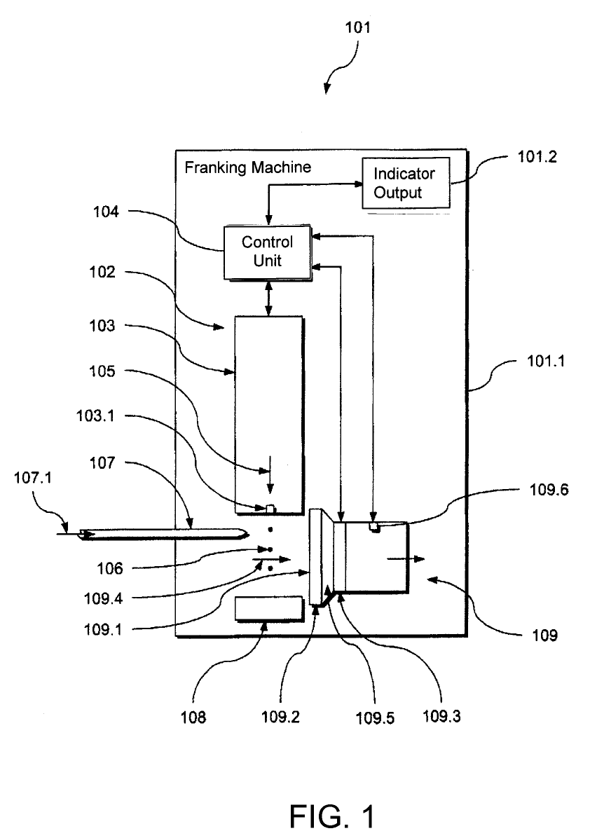

FIG. 1 is a schematic view of a preferred embodiment of the printing mechanism according to the invention, with which a preferred variant of the method for operating a printing mechanism can be implemented; and

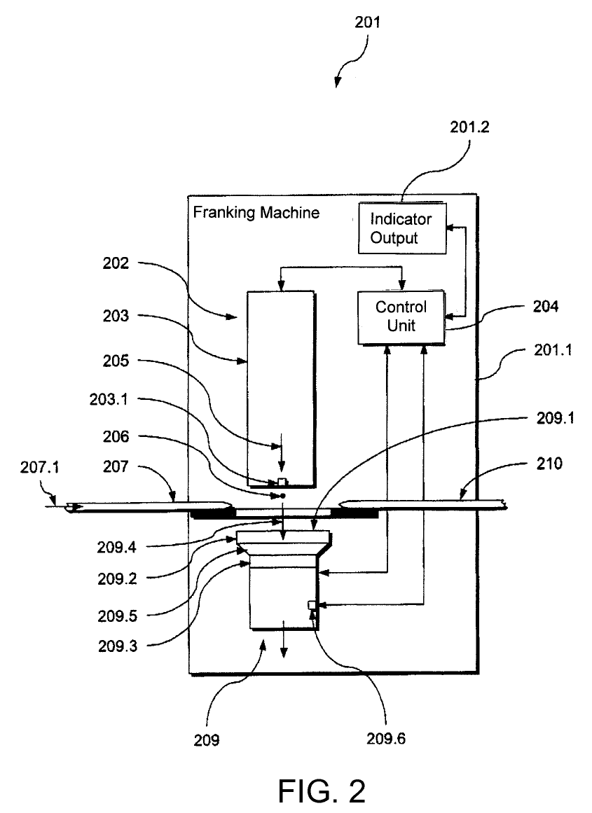

FIG. 2 is a schematic representation of another preferred embodiment of the novel printing mechanism, with which another preferred variant of the novel method for operating a printing mechanism can be implemented.

### DETAILED DESCRIPTION OF THE INVENTION

Referring now to the figures of the drawing in detail and first, to FIG. 1 thereof, with reference to a franking machine 101, we shall first specify a preferred embodiment of the novel printing mechanism 102 of the franking machine 101, with which a preferred variant of the novel method for operating a printing mechanism is carried out.

The printing mechanism 102 comprises a print head 103 and a central control unit in the form of a controller 104. The print head 103 works by the ink jet principle, which is sufficiently well known, so that it shall not be discussed in further detail here. The print head 103 has a plurality of nozzles 103.1, lined up in a row perpendicular to the plane of the drawing, from which it ejects ink drops 106 in familiar fashion corresponding to the control signals of the controller 104 in the direction of the arrow 105.

The ejecting of the ink drops 106 occurs in a printing mode of the print head 103, in order to produce a franking imprint on a substrate in the form of a letter 107. In this printing mode, the letter 107 is transported past the print head 103 in the direction 107.1, while the print head is stationary relative to the housing 101 of the franking machine. The print head is in a printing position in which the nozzles 103.1 are arranged close to the surface of the letter 107 being printed upon.

In the condition shown in FIG. 1, the print head 103 is in a free spray mode. Here, again, there is an ejecting of ink drops 106, but this serves a cleaning purpose. In this free spray mode, the print head 103 is in a free spray position, differing from the printing position. In the present case, the print head 103 reaches its free spray position by being swiveled in a plane perpendicular to the plane of the drawing relative to the printing position. However, other variants of the invention can also provide that the print head be moved in any other manner between its printing position and its free spray mode.

In the free spray position, an ink sump 108 is arranged opposite the nozzles 103.1 of the print head 103 in the direction of the arrow 105. In this ink sump 108, the ink drops 106 ejected from the nozzles 103.1 during the free spraying are caught, for example, by a fleece inlay of the ink sump 108 or the like.

In the free spray position—and therefore in the free spray mode of the print head 103, which in the present example represents a first operating condition of the print head 103—the print nozzles 103.1 of the print head 103 are still arranged in direct proximity to a suction inlet 109.1 of a suction mechanism 109. This suction mechanism 109 serves to such away at certain moments of time the ink spray formed when the ink drops 106 are ejected from the nozzles 103.1 or when the ink drops 103.1 strike an object, such as the letter 107 or the ink sump 108.

In the region of the suction inlet 109.1 there is provided a filter mechanism in the form of a replaceable filter 109.2, which filters the ink at once from the air flow drawn in. To accomplish the suction, the suction mechanism 109 furthermore has a fan 109.3 connected after the filter 109.2 in the direction of flow, which at certain predetermined times is activated by the controller 104 to create a suction flow 109.4. The fan 109.3 is connected to the filter 109.2 by a closed duct 109.5, which ensures that the suction mechanism 109 draws in air solely through the filter 109.2. This guarantees a reliable suctioning of the ink spray.

Thanks to arranging the suction inlet 109.1 directly next to the nozzles 103.1 in this way, one ensures that a basically undisturbed suction flow 109.4 is formed between the nozzles 103.1 and the suction inlet 109.1 during the operation of the suction mechanism. Thanks to this spatially close coordination of the suction inlet 109.1 with the nozzles 103.1, it is possible in advantageous fashion to such away the ink spray at once as it is formed, without it having to pass by components, especially functional components of the printing mechanism 102, whose fouling is undesirable. Furthermore, no sudden changes of direction of the suction flow 109.4 occur along the short path between the particular nozzle 103.1 and the suction inlet 109.1, so that one can avoid ink deposits due to centrifugal force in the region of such changes of direction of the suction flow 109.4.

As can be seen from FIG. 1, the suction flow 109.4 between the nozzles 103.1 and the suction inlet 109.1 does not pass by any obstacles noticeably constricting the flow cross section. In this way, one can avoid unwanted ink deposits, which would otherwise occur at such constrictions due to the flow deflection occurring there. It should be noted that this configuration is especially easy to achieve, thanks to the separate free spray position.

Of course, the filter mechanism in other variants of the invention can also be provided at a certain distance from the suction inlet 109.1 in the flow direction. However, the present configuration has the advantage that the fouling of the components in the suction mechanism 109 is also minimized thanks to having the filter 109.2 directly at the suction inlet 109.1.

The use of suction during the free spraying is of special advantage, since the print head 103 during the free spraying ejects the ink drops 106 for a longer distance than when printing, so that there is a higher likelihood of forming an ink spray.

The suctioning of the ink spray by the suction mechanism 109 can be controlled at any suitable time by the controller 104. In the most elementary case, the suction occurs continuously during the entire operating time of the printing mechanism 102. In the present example, however, the suctioning occurs only at certain predetermined times.

This makes possible, on the one hand, an operation of the suctioning as needed. On the other hand, thanks to the suctioning as needed, one can prevent the filter 109.2 from becoming clogged with other impurities, such as paper dust, due to the constant operation of the suction, which would considerably shorten its lifetime.

In the present example, specifically, the controller 104 actuates the fan 109.3 so that it runs during the free spraying of the print head 103 and thus produces the suction flow 109.4. Furthermore, there is a predetermined run-up time for the fan 109.3 prior to the free spraying and a predetermined run-down time after the free spraying, in order to achieve a reliable and as complete as possible suctioning of the ink spray.

In certain variants of the invention, the suction mechanism 109 can have an intensive suction mode in which the fan 109.3 works at so high a speed that the suction flow 109.4 formed between the nozzles 103.1 and the suction inlet 109.1 is enough to deflect the ink drops 106 ejected from the nozzle into the suction inlet 109.1. In this way, it is possible to do away with the free spraying onto the ink sump 108 or at least make it more modest.

The intensive suction mode can be the only available suction mode of the suction mechanism 109. Preferably, however, the suction mechanism 109 has another suction mode, in which the suction flow formed between the nozzles 103.1 and the suction inlet 109.1 has a smaller volume flow than in the intensive suction mode. The other suction mode can be used, for example, during the printing mode of the print head 103, when the suction flow basically does not deflect the path of ink drops 106 ejected from the nozzles 103.1 and diverts the ink droplets of smaller diameter, forming the ink spray, into the suction inlet 109.1.

Furthermore, the increased volume flow in the intensive suction mode during the free spraying has the benefit that ink collecting on the surface of the filter 109.2 is sucked into the filter and thus avoids the formation of an ink crust, clogging the filter 109.2. Of course, under the guidance of the controller 104, an appropriately increased volume flow of the suction can also be used for other purposes from time to time, other than the free spraying.

In the present example, a monitoring device is furthermore realized via the controller 104 to monitor the condition of the filter 109.2. The controller 104 is configured to put out an indication as to the status of the filter to a user of the franking machine 101 via an interface 101.2. Thus, an optical and/or acoustic indication as to the need to change the filter mechanism can be put out via the interface 101.2. In this way, one can achieve a timely replacement of the filter mechanism and thus a constant reliable filtering, even over lengthy operating period of the printing mechanism.

In especially simple and advantageously configured variants of the franking machine 101, the controller 104 monitors the activation of the nozzles 103.1 of the print head 103 (for example, by a drop counting) and the activation of the suction mechanism 109 and draws conclusions as to the current status of the filter 109.2 from this. Thus, for example, by means of experiential values and the operating volume of the print head (drop counting) and the suction mechanism, one can determine how much ink must have been taken up by the filter 109.2 at a given time. Of course, however, in other variants of the franking machine 101, there can also be an actual measurement of at least one quantity representative of the status of the filter 109.2, which is then used for purposes of the monitoring.

In order to make sure that an adequate and reliable suctioning is constantly produced by the suction mechanism 109, a monitoring device is provided to monitor the suction flow 109.4. This monitoring device is realized, in turn, by the controller 104 and a suitable flow sensor 109.6 of the suction mechanism 109, connected to the former. The flow sensor 109.6, for example, detects a value representative of the current volume flow of the suction flow 109.5 and furnishes this to the controller 104. The controller 104 then regulates the speed of the fan 109.3, using a predetermined setpoint, so that the desired volume flow is produced.

In this way, one can assure in simple manner that, regardless of the rising flow resistance of the filter 109.2 with increasing ink uptake, basically a constant suction flow 109.4 is produced and predetermined for the particular suction mode, as long as this can still be established by the fan 1090.3 against the flow resistance of the filter 109.2. No later than when the flow resistance of the filter 109.2 becomes so large that the fan 109.3 can no longer compensate for this by high speed of rotation, but preferably in good time prior to this, a corresponding indication is put out via the interface 101.2 to replace the filter 109.2.

The suction mechanism 109 can deliver the air drawn in by corresponding ventilation slots (not shown) or the like, out from the franking machine 101. However, it is clear that such ventilation slots need not necessarily be present. Instead, it is also possible to bring the filter air back inside the housing 101.1, and therefore achieve a circulating air operation.

FIG. 2 shows another preferred sample embodiment of an invented franking machine 201 with a printing mechanism 202, which does not differ fundamentally in construction or operation from the design in FIG. 1, so that we shall only discuss the differences here. In particular, identical or similar components shall be given a reference number increased by 100, and we refer to the above remarks with regard to their description.

A major difference in the franking machine 201 from the franking machine 101 is that the suction mechanism 209 is arranged opposite the print head 203 of the printing mechanism 202 in the direction of ejection 205 of the ink drops 206. The print head 203 is in its printing position, in which it produces a franking imprint on a letter 207 in the print mode, while the letter is transported past the nozzles 203.1 of the print head 203 in the direction 207.1.

The free spray mode of the print head 203 is activated by the controller 204 between the printing of two consecutive letters 210 and 207. In the gap between the two letters 210 and 207, the suction flow 209.4 is produced between the nozzles 203.1 and the suction inlet 209.1 of the suction mechanism 209, by which the ink spray is then sucked away.

The filter 209.2 here also constitutes the ink sump, while the suction flow 209.4 ensures that no ink accumulations, or so-called ink stalagmites, form on the side of the filter 209.2 facing the print head 203. Instead, the entire ink is sucked into the filter 209. Thus, it is possible to have the filter 209.2 constituting the ink sump arranged spatially close to the print head 203, which would not otherwise be possible, in order to avoid contact between the print head 203 and such accumulations.

In the present example, the suction mechanism is active both during the printing and during the free spraying. Of course, a suctioning with a higher volume flow is possible during the free spraying, in order to achieve a good distribution of the ink in the filter 209.2.

As soon as a letter 207 or 210 moves into the region between the print head 203 and the suction inlet 209.1 in the printing mode of the print head 203, the suction flow 209.4 between the nozzles 203.1 and the suction inlet 209.1 is deflected and ultimately interrupted, so that it does not disturb the ink drops 206 when producing the imprint on the letter 207 or 210. When the letter 207 or 210 afterwards frees up the stretch between the nozzles 203.1 and the suction inlet 209.1 once again, the ink spray produced during the printing can be sucked away at once with no further control effort.

Of course, in other variants of the franking machine 201 one can interrupt the suction by simply switching off the suction mechanism 209. Likewise, the interruption and/or deflection of the suction flow 209.4 can also be accomplished by mechanical means, such as moving diaphragms, baffles, or the like.

The invention has been described above solely by means of examples from the field of franking machines. However, it is clear that the invention can also be used with any other printing mechanisms.

1: A printing mechanism, comprising:
an ink jet print head having at least one nozzle;
a suction mechanism configured for suctioning away ink spray formed when ink drops are ejected from said at least one nozzle of said print head;
said suction mechanism having a suction inlet which, in at least one first operating condition of said print head, with said print head ejecting ink droplets from said at least one nozzle, is disposed directly adjacent said at least one nozzle, thereby defining a substantially undisturbed suction flow between said at least one nozzle and said suction inlet.

2: The printing mechanism according to claim 1, wherein said ink jet print head is mounted in a franking machine.

3: The printing mechanism according to claim 1, wherein the suction flow between said at least one nozzle and said suction inlet is defined so as not to pass by any obstacles constricting a flow cross section.

4: The printing mechanism according to claim 1, wherein said print head, in the first operating condition, is disposed at a printing position in which said at least one nozzle is used to produce an imprint on a substrate positioned with respect to said print head.

5: The printing mechanism according to claim 1, wherein said print head has a free ejection mode, in which said at least one nozzle is activated for cleaning purposes, and said print head is in said free ejection mode in said first operating condition.

6: The printing mechanism according to claim 5, wherein:
said print head is driven into a free ejection position in said free ejection mode thereof; and
said free ejection position differs from a printing position adopted by said print head during printing on a substrate.

7: The printing mechanism according to claim 5, which further comprises an ink catching mechanism disposed opposite said at least one nozzle of said print head in said free ejection mode.

8: The printing mechanism according to claim 5, which further comprises:
a control unit, connected to said suction mechanism and to said print head, for actuating said suction mechanism during said free ejection mode; and
for operating said suction mechanism with a predetermined run-up time prior to activation of said free ejection mode and/or with a predetermined run-down time following a deactivation of said free ejection mode.

9: The printing mechanism according to claim 1, wherein said suction mechanism has at least one intensive suction mode, in which said suction flow produced between said at least one nozzle and said suction inlet is sufficient to deflect ink drops ejected from said at least one nozzle into said suction inlet.

10: The printing mechanism according to claim 9, wherein said suction mechanism has at least one other suction mode, in which said suction flow formed between said at least one nozzle and said suction inlet has a lower volume flow than in said intensive suction mode.

11: The printing mechanism according to claim 10, wherein said other suction mode is defined such that said suction flow:
substantially does not deflect a trajectory of ink drops ejected from said at least one nozzle; and
deflects substantially only smaller ink droplets forming an ink spray into said suction inlet.

12: The printing mechanism according to claim 9, which further comprises a control unit connected to said suction mechanism and to said print head, said control unit being configured to:
actuate said suction mechanism such that said intensive suction mode is present during a free ejection mode of said print head; and
actuate said print head into the free ejection mode of the print head between directly consecutive printing of two substrates.

13: The printing mechanism according to claim 11, wherein said print head, in said free ejection mode, is situated in a printing position, in which an imprint can be produced on a substrate positioned relative to the print head by said at least one nozzle in a print mode of said print head.

14: The printing mechanism according to claim 1, wherein said suction mechanism includes a filter mechanism.

15: The printing mechanism according to claim 14, wherein said filter mechanism is disposed in a vicinity of said suction inlet and/or said filter mechanism is exchangeable.

16: The printing mechanism according to claim 14, wherein:
said suction mechanism includes a fan mechanism connected downstream of said filter mechanism in a direction of flow; and
said filter mechanism is connected to said fan mechanism such that said fan mechanism draws in air substantially exclusively through said filter mechanism.

17: The printing mechanism according to claim 16, which further comprises at least one air duct connected between said filter mechanism and said fan mechanism.

18: The printing mechanism according to claim 14, which comprises:
a monitoring device disposed to monitor a condition of said filter mechanism, and configured to output an indication relating to said condition of said filter mechanism.

19: The printing mechanism according to claim 18, wherein said monitoring device is configured to provide an output indicative of a need to replace said filter mechanism to a user of the printing mechanism.

20: The printing mechanism according to claim 18, wherein said monitoring device is configured to monitor an activation of said print head and an activation of said suction mechanism and to draw conclusions concerning a current status of said filter mechanism therefrom.

21: The printing mechanism according to claim 1, which comprises:
a control unit connected to said suction mechanism, said control unit including a monitoring device for monitoring a suction flow; and
wherein said control unit is configured to regulate the suction flow by using a predetermined setpoint.

22: The printing mechanism according to claim 1, wherein said suction mechanism is configured to interrupt and/or deflect a suction flow at certain times.

23: The printing mechanism according to claim 22, wherein said suction flow is interrupted and/or deflected during a printing onto a substrate.

24: The printing mechanism according to claim 1, wherein said print head is fastened to a base element and said print head is stationary with respect to said base element when producing an imprint on a substrate, while the substrate is moved past said print head relative to said base element.

25: A franking machine, comprising a printing mechanism according to claim 1.

26: A method of operating a printing mechanism having an ink jet print head, the method comprising:
ejecting ink drops from at least one nozzle of the ink jet print head in an ejecting step;
suctioning ink spray developing during said ejecting step away with a suction inlet disposed directly adjacent said at least one nozzle and establishing a substantially undisturbed suction flow between said at least one nozzle and said suction inlet.

27: The method according to claim 26, which comprises operating said printing mechanism in a franking machine.

28: The method according to claim 26, which comprises establishing said suction flow between said at least one nozzle and said suction inlet substantially without any obstacles constricting a flow cross section.

29: The method according to claim 26, which comprises suctioning said ink spray away in a printing position of said print head in which said at least one nozzle is positioned to produce an imprint on a substrate that is correspondingly positioned with respect to said print head.

30: The method according to claim 26, which comprises:
placing said print head in a free ejection mode, in which said at least one nozzle is activated for cleaning purposes; and
suctioning away said ink spray while said print head is in said free ejection mode.

31: The method according to claim 30, which comprises driving said print head into a free ejection position for said free ejection mode, said free ejection position differing from a printing position adopted by said print head when printing on a substrate.

32: The method according to claim 30, which comprises establishing at least one of a predetermined run-up time for suctioning prior to activation of said free ejection mode and/or a predetermined run-down time for suctioning after deactivation of said free ejection mode.

33: The method according to claim 26, which comprises providing at least one intensive suction mode wherein said suction flow produced between said at least one nozzle and said suction inlet is sufficient to deflect ink drops ejected from said nozzle into said suction inlet.

34: The method according to claim 33, which comprises selectively driving the suction inlet in providing another suction mode wherein said suction flow formed between said at least one nozzle and said suction inlet has a lower volume flow than in said intensive suction mode.

35: The method according to claim 34, which comprises establishing said suction flow in said other suction mode such that:
a trajectory of ink drops ejected from said nozzle is substantially not deflected; and
ink droplets having a smaller diameter and forming an ink spray are deflected into said suction inlet.

36: The method according to claim 26, which comprises:
providing said intensive suction mode during a free ejection mode of said print head; and
driving said print head in said free ejection mode between printing on two directly consecutive substrates.

37: The method according to claim 36, wherein said print head in said free ejection mode is situated in a printing position in which an imprint can be produced on a substrate positioned relative to said print head by said at least one nozzle in a print mode of said print head.

38: The method according to claim 26, which comprises filtering said suction flow through a filter mechanism.

39: The method according to claim 38, which comprises drawing in air to create said suction flow substantially only through said filter mechanism.

40: The method according to claim 38, which comprises:
monitoring a condition of said filter mechanism; and
outputting at least one indication relating to said condition of said filter mechanism.

41: The method according to claim 40, which comprises providing an output indicative of a need to replace said filter mechanism to a user of said printing mechanism.

42: The method according to claim 40, which comprises monitoring an activation of said print head and an activation of said suction mechanism and drawing conclusions therefrom as to a current status of said filter mechanism.

43: The method according to claim 40, which comprises:
suctioning off said ink spray with increased volume flow at certain times; and
choosing said increased volume flow to aspirate ink collecting on said surface of said filter mechanism into said filter mechanism.

44: The method according to claim 26, which comprises selectively interrupting and/or interrupting the deflecting said suction flow at certain times.

45: The method according to claim 44, which comprises interrupting and/or deflecting said suction flow while a substrate is being printed on.

46: The method according to claim 26, which comprises:
monitoring the said suction flow; and
regulating the said suction flow by using a predetermined setpoint.
